(19) United States
(12) Patent Application Publication
(10) Pub. No.: US 2023/0229736 A1
(43) Pub. Date: Jul. 20, 2023

(54) EMBEDDING OPTIMIZATION FOR A MACHINE LEARNING MODEL

(71) Applicant: Lemon Inc., Grand Cayman (KY)

(72) Inventors: Xia XIAO, Los Angeles, CA (US); Ming CHEN, Los Angeles, CA (US); Youlong CHENG, Los Angeles, CA (US)

(21) Appl. No.: 17/579,566

(22) Filed: Jan. 19, 2022

(51) Int. Cl. G06K 9/62; G06F 17/16; G06N 20/00

(52) U.S. Cl. CPC G06K 9/6257; G06F 17/16; G06N 20/00

(57) ABSTRACT

Embodiments of the present disclosure relate to feature selection via an ensemble of gating layers. According to embodiments of the present disclosure, a set of model parameter values for a machine learning model and a set of embedding vectors are determined for an input field of the machine learning model. The machine learning model is constructed to map an input sample in the input field to an embedding vector in the embedding vectors and process the embedding vector with the model parameter values to generate a model output. The machine learning model is trained by updating the model parameter values and the embedding vectors according to at least a first training objective function, the first training objective function being based on an orthogonality metric between embedding vectors in the embedding vectors and based on a difference between the model output and a ground-truth model output.

### BACKGROUND

Machine learning models, especially deep neural networks have been used in artificial intelligence (AI) and computer vision fields. These models have shown promising performance in many tasks including recommendation, visual object recognition, natural language processing, and so on.

A model input is generally converted into a vector representation for a machine learning model to process. Real-world tasks usually involve a large amount of categorical input fields with high cardinality (i.e. the number of unique values). One-hot encoding is a standard way to represent such categorical features with one-hot vectors. To reduce the memory cost of one-hot encoding, the machine learning model may be configured to first map the high-dimensional sparse one-hot vectors into real-valued dense embedding vectors via an embedding layer. Such embedding vectors are subsequently used in the machine learning model for obtaining the required model output. The learning of the embedding vectors may be important to the processing accuracy and memory efficiency.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, where:

FIG. 1 illustrates a block diagram of an environment in which the embodiments of the present disclosure can be implemented;

FIG. 2 illustrates a block diagram of example architecture of a machine learning model in accordance with some example embodiments of the present disclosure;

FIG. 3 illustrates a flowchart of a process for training the machine learning model in accordance with some example embodiments of the present disclosure;

FIG. 4 illustrates a block diagram of example architecture of a machine learning model in accordance with some further example embodiments of the present disclosure;

FIG. 5 illustrates a flowchart of a process for training the machine learning model in accordance with some further example embodiments of the present disclosure;

FIG. 6 illustrates a diagram of an example algorithm for training the machine learning model in accordance with some embodiments of the present disclosure; and

FIG. 7 illustrates a block diagram of an example computing system/device suitable for implementing example embodiments of the present disclosure.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “model” is referred to as an association between an input and an output learned from training data, and thus a corresponding output may be generated for a given input after the training. The generation of the model may be based on a machine learning technique. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network” , or “learning network,” which are used interchangeably herein.

Generally, machine learning may usually involve three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. At the application stage, the resulting machine learning model may be used to process an actual model input based on the set of parameter values obtained from the training process and to determine the corresponding model output.

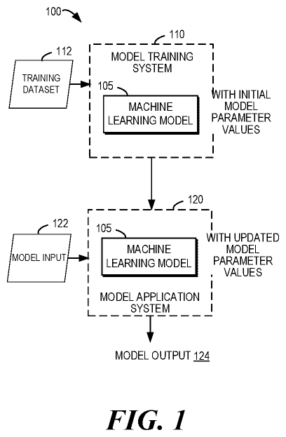

FIG. 1 illustrates a block diagram of an environment 100 in which the embodiments of the present disclosure can be implemented. In the environment 100, it is expected to train and apply a machine learning model 105 for a prediction task. The machine learning model 105 may be of any machine learning or deep learning architectures, for example, a neural network.

In practical systems, the machine learning model 105 may be configured to process a model input and generate a model output indicating a prediction or classification result for the model input. The processing task may be defined depending on practical applications where the machine learning model 105 is applied.

As an example, in a recommendation system, the machine learning model 105 may be configured to predict one or more items or objects which a user is of interest and provide a recommendation to the user based on the prediction. In this example, the model input may comprise contextual information related to the recommendation task. The model output may indicate predicted probabilities that the user is interest of the items. As another example, in a financial application, machine learning model 105 may be configured to predict the sales of a product at a future time. In this example, the model input may comprise the future time, information related to the product and/or other related products, historical sales of the product and/or other related products, information related to target sales areas of the product, and so on. The model output may indicate the predicted sales. It would be appreciated that only a limited number of examples are listed above, and the machine learning model 105 may be configured to implement any other prediction tasks.

The machine learning model 105 may be constructed as a function which processes the model input and generates a model output. The machine learning model 105 may be configured with a set of model parameters whose values are to be learned from training data through a training process. In FIG. 1, the model training system 110 is configured to implement the training process to train the machine learning model 105 based on a training dataset 112.

The training dataset 112 may include a large number of model inputs provided to the machine learning model 105 and labeling information indicating corresponding ground-truth outputs for the model inputs. At an initial stage, the machine learning model 105 may be configured with initial model parameter values. During the training process, the initial model parameter values of the machine learning model 105 may be iteratively updated until a learning objective is achieved.

After the training process, the trained machine learning model 105 configured with the updated model parameter values may be provided to the model application system 120 which applies a real-world model input 122 to the machine learning model 105 to output a model output 124 for the model input 122.

In FIG. 1, the model training system 110 and the model application system 120 may be any systems with computing capabilities. It should be appreciated that the components and arrangements in the environment shown in FIG. 1 are only examples, and a computing system suitable for implementing the example implementation described in the subject matter described herein may include one or more different components, other components, and/or different arrangement manners. For example, although shown as separate, the model training system 110 and the model application system 120 may be integrated in the same system or device. The embodiments of the present disclosure are not limited in this respect.

Typically, a machine learning model is configured to map a model input to an embedding vector for subsequent processing. Embedding vectors can characterize feature information of the model input. The embedding vectors are expected to distinguish feature information of different model inputs to facilitate the machine learning model to make accurate predictions for those model inputs. Currently, it has been proposed to learning the embedding vectors together with the model parameter values of the machine learning model. However, more accurate and efficient learning of embedding vectors is still desired.

On the other hand, the dimension of the embedding vectors is traditionally fixed and configured by the model developers based on experience, which may result in some deficiencies. If a high dimension of embedding vectors is configured, it leads to increased memory usage and computational cost, and if a low dimension of embedding vectors is configured, it may be insufficient to capturing features with large cardinality.

According to embodiments of the present disclosure, there is proposed a solution for learning embedding vectors for a machine learning model. In this solution, an orthogonality constraint is introduced for learning the embedding vectors. With the orthogonality constraint, embedding vectors for a certain input field can be more informative and help to achieve significant improvement on the model performance. In some further embodiments, instead of providing fixed dimension of embedding vectors for different input fields, the dimension of embedding vectors can be dynamically learned together with the machine learning model for the input fields, which can effectively compress the model and reduce memory usage, without compromising the model performance.

Before describing the embodiments of learning the embedding vectors and the dimension reduce of the embedding vectors, it is first introduced example architecture and work principle of the machine learning model.

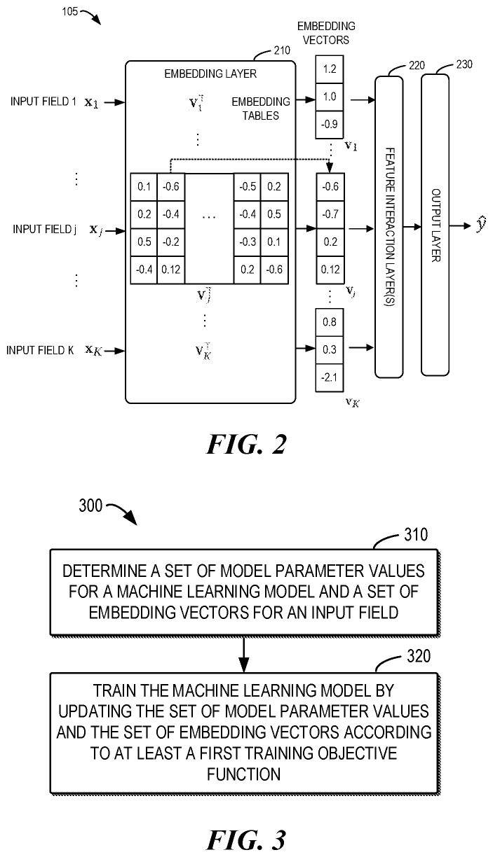

FIG. 2 illustrates a block diagram of example architecture of the machine learning model 105 in accordance with some example embodiments of the present disclosure.

For the purpose of discussion, it is assumed that a model input to the machine learning model 105 involves K input fields, where K is equal to or larger than one. Respective input samples in the K input fields are provided to the machine learning model 105. An input field may comprise categorical feature information useful for determining the model output. As an example, if the machine learning model 105 is configured to implement a recommendation task, the model input may include contextual information fields. The contextual information fields may include, for example, a recommendation time field, an item category field, an item profile field, an item price field, and so on. It is noted that in some embodiments, the machine learning model 105 may involve a single input field.

In some embodiments, the raw input samples in the K input fields may be represented by one-hot vectors (or one-hot codes), denoted as x₁ ∈ [symbol] ^{C}^{₁}, . . . , x_{K} ∈ [symbol] ^{C}^{_{K}}, where the field dimensions C₁, . . . C_{K} are the cardinalities of the input fields (e.g., there are C₁ different potential input samples in the first input field).

A one-hot vector may comprise a number of elements each valued with either 0 or 1. For a certain input field, different input samples may be encoded with different one-hot vectors with the same dimension (or size). For example, in a recommendation time field, input samples of different time intervals may be represented by different one-hot vectors. For a query field, different character sequences may be represented by different one-hot vectors.

As illustrated, the machine learning model 105 comprises an embedding layer 210, one or more feature interaction layers 220, and an output layer 230. Typically, the one-hot vectors may be in a high dimensional space, which means that the one-hot vectors are of a relatively large size and comprise a large number of elements. The embedding layer 210 is configured to covert the input samples in a high dimensional and sparse space into embedding vectors in a low dimensional and dense embedding space.

An embedding vector may be in a small dimension and comprise a smaller number of embedding elements than the corresponding one-hot vector. Each element in the embedding vector may have a real value. The embedding vector may sometimes be referred to as an “embedding representation,” “latent vector,” “feature,” or “feature representation.” An embedding vector for a specific input sample in an input field may be learned with the machine learning model 105. This embedding vector can allow the input samples to be represented and classified in a novel way, by using a location in an embedding space, rather than a conventional unique one-hot code. The embedding space may not be designed by human beings, but rather learned from training data of the machine learning model 105.

For a certain input field, the embedding layer 210 may refer to a set of embedding vectors (referred to as an “embedding table”) to select a corresponding embedding vector for a specific input sample in this input field. Herein, the terms a “set of embedding vectors” and an “embedding table” are used interchangeably. There may be one-to-one mapping between input samples (or one-hot vectors) in the input field and embedding vectors in the embedding table. Thus, the embedding table is used as a look-up table for the input field. Embedding vectors in a same embedding table may have the same size, i.e., the same number of embedding elements, and embedding vectors in different embedding tables may have the same size or different sizes.

As illustrated, the K sets of embedding vectors (embedding tables) for the K input fields are represented as V₁ ∈ [symbol] ^{C}^{₁}^{×d}^{₁}, . . . , V_{K} ∈ [symbol] ^{C}^{_{K}}^{/d}^{_{K}}, where d₁, . . . , d_{K} denote the dimensions of embedding vectors in the embedding tables and each dimension dⱼ (j=1, . . . , K) may be equal to or larger than one. An embedding vector mapped to an input sample Xᵢ for an i-th input field (i=1, . . . , K) may be represented v₁=Vᵢ^{T}xᵢ, providing that embedding vectors are arranged column-wisely in the embedding table. It is noted that embedding vectors may also be arranged row-wisely in an embedding table. In the following description, for the purpose of discussion only, it is assumed that an embedding vector is corresponding to a column in an embedding table.

In the illustrated example in FIG. 2, the dimension d₁ of the embedding table v₁ is three, and an embedding vector [1.2, 1.0, −0.9] in this embedding table may be mapped to a certain input sample x₁. Similarly, the dimension dⱼ of the embedding table Vⱼ is 4, and an embedding vector [−0.6, −0.7, 0.2, 0.12] in this embedding table may be mapped to a certain input sample xⱼ, and the dimension d_{K} of the embedding table V_{K} is 3, and an embedding vector [0.8, 0.3, −2.1] in this embedding table may be mapped to a certain input sample x_{K}. It is noted that the values for the embedding vectors are provided in FIG. 2 only for the purpose of illustrations. Those values may be updated in the training process of the machine learning model and are set for model application after the optimized values are found in the training process.

The embedding layer 210 may receive input samples of all the K input fields. The K input samples of the model input may be concatenated to form an input vector, denoted by x=[x₁; x₂; . . . ; x_{K}]. Given the embedding tables [symbol] ={V₁, V₂, . . . , V_{K}} for the K input fields, the embedding layer 210 may provide K corresponding embedding vectors v, which may be represented as follows:

v=[v₁; v₂; . . . ; v_{K}]=[V₁^{T}x₁; V₂^{T}x₂; . . . ; V_{K}^{T}x_{K}]:= [symbol] x (1)

where [symbol] is an embedding look-up operator.

The embedding vectors v is feed to the interaction layers 220, which are configured to process the embedding vectors v to model complex feature crossing. The interaction layers 220 may provide hidden features of the embedding vectors to the output layer 230, which is configured to generate a model output for the specific task.

In some embodiments, the feature crossing techniques applied by the interaction layers 220 may include any of a vector-wise type and a bit-wise type. Models with vector-wise crossing explicitly introduce interactions by the inner product, such as Factorization Machine (FM), DeepFM and AutoInt. The bit-wise crossing, in contrast, implicitly adds interaction terms by element-wise operations, such as the outer product in Deep Cross Network (DCN), and the Hadamard product in NFM and DCN-V2.

The interaction layers 220 and the output layer 230 may be configured with a set of model parameter values. Each layer of the interaction layers 220 and the output layer 230 may be configured with a subset of the model parameter values to process its input and generate its output. Those layers may be connected layer-by-layer and an output from a layer may be provided to a next layer as an input. The output generated by a layer and conveyed to a next layer in the machine learning model 105 generally referred to as “latent features,” “feature representations,” or “latent vectors.”

The model output (represented as [symbol] ) may depend on the specific task configured to be implemented by the machine learning model 105. In some examples, the model input [symbol] may comprise one or more predicted probabilities or scores of potential prediction results or classification results. As a concrete example, for the recommendation task, the model output [symbol] may comprise a predicted probability or score indicating whether the user is interest of a certain item. It is noted that the model output may be configured as other type of values or results. The model output [symbol] generated by the machine learning model 105 may be represented as follows:

ŷ=ψ(v|Θ)=ψ( [symbol] x|Θ)=ϕ(x| [symbol] , Θ) (2)

where Θ represents the set of model parameter values for the machine learning model 105, ψ(·|Θ) represents a processing function applied on the embedding vectors provided from the embedding layer 210, and ϕ=ψ∘ [symbol] represents a processing function applied on the raw model input x.

The embedding tables [symbol] (e.g., valuing of embedding elements in the embedding vectors) and the set of model parameter values Θ are determined through a training process of the machine learning model 105.

FIG. 3 illustrates a flowchart of a process 300 for training the machine learning model in accordance with some example embodiments of the present disclosure. The process 300 may be implemented at the model training system 110 in the environment 110.

At block 310, the model training system 110 determines a set of model parameter values for the machine learning model 105 and a set of embedding vectors for an input field of the machine learning model 105. At the initial stage of the training process, the set of model parameter values Θ and the embedding tables [symbol] may be initialized.

At block 320, the model training system 110 trains the machine learning model 105 by updating the set of model parameter values Θ and the set of embedding vectors [symbol] according to at least a training objective function (sometimes referred to as a “first training objective function”).

The training objective function can be designed and used for learning the embedding tables [symbol] and the set of model parameter values Θ. In some embodiments, a training objective function is configured to measure a difference (or error) between the predicted model outputs of the machine learning model 105 from training data and the ground-truth outputs. Such a difference or error is also called a loss of the machine learning, and the objective function may also be referred to as a loss function.

During training, the embedding tables [symbol] and the set of model parameter values Θ are iteratively updated to reduce the loss calculated from the objective function. A training objective may be achieved until the training objective function is optimized, for example, until the calculated error is minimized or reaches a desired threshold value. An example optimization of the training objective function may be as follows:

$${min}_{𝕍 , Θ} {ℒ}_{train} ( 𝕍 , Θ ) := - \frac{1}{N} {\sum }_{j = 1}^{N} ( {y}_{j} log ( {\hat{y}}_{j} ) + ( 1 - {y}_{j} ) log ( 1 - {\hat{y}}_{j} ) ) \qquad ( 3 )$$

where [symbol] ₜᵣₐᵢₙ( [symbol] , Θ) represents the training objective function for learning [symbol] and Θ, N is the total number of model inputs applied to the machine learning model 105 during training process, [symbol] ⱼ represents a ground-truth model output for a predicted model output [symbol] ⱼ of the j-th model input. In Eq. (3), the training objective function is based on a Log-loss on the training data, and the optimization is to update [symbol] and Θ such that [symbol] ₜᵣₐᵢₙ( [symbol] , Θ) is minimized.

In accordance with embodiments of the present disclosure, in addition to the conventional constraint on the loss measured from the predicted model outputs and the ground-truth model outputs, it is proposed to introduce an orthogonality constraint on an embedding table. Specifically, the training objective function can be designed based on an orthogonality metric between embedding vectors in an embedding table for a certain input field. The orthogonality metric is used to measure if embedding vectors in the embedding table are orthogonal to each other. It is expected that an embedding table with an orthogonality property can be learned. By obtaining orthogonal embedding vectors, different input samples in an input field can be represented with more informative and distinguishing vectors, which can help to achieve significant improvement on the model performance. The orthogonality metric can be added as an orthogonality regularization term into the training objective function in Eq. (3) that is based on the model output error.

With the orthogonality constraint, optimization of an embedding table is to search for a set of embedding vectors that are orthogonal to each other. Given an embedding table Vⱼ ∈ [symbol] ^{C}^{ⱼ}^{×d}^{ⱼ} for an input field j, its dⱼ different embedding vectors for the input field j may be denoted by V_{j,1}, . . . , _{j,d}_{ⱼ} ∈ [symbol] Cⱼ in the embedding space. The presence of correlation between these embedding vectors may complicate the selection procedure.

Specifically, presuming that the most predictive embedding vector V_{j,p} has been selected, it would be problematic if it greedily selects the next embedding vector V_{j,q} that brings the largest loss drop when included in. For instance, if V_{j,p} is not orthogonal to V_{j,q} (i.e., V_{j,q} [symbol] V_{j,p}), V_{j,q} may be decomposed to two components as follows:

V_{j,q}=p+p^{⊥}, (4)

where a first component p is determined based on the selected V_{j,p}, for example, p=cV_{j,p} (where c is a predetermined value) or p=V_{j,p} and a second component p^{⊥} is orthogonal to the first coponent p (i.e., p^{⊥} ⊥p). Therefore, it would be difficult to determine whether updates during the training process are attributed to the existing direction p or the new factor p^{⊥}.

To address this issue, in some embodiments of the present disclosure, it is proposed to train the K embedding tables [symbol] for the K input fields with Soft Orthogonal (SO) regularizations. More specifically, an embedding table Vⱼ may be constructed as a matrix, and an orthogonality metric for this embedding table may be determined based on a difference between a transpose of the matrix times the matrix itself and an identity matrix.

In some examples, considering that the dimensions for the K embedding tables may be different, the orthogonality metric for a certain embedding table may be further determined based on a division of the difference for this embedding table and its dimension dⱼ. For the K embedding tables [symbol] , their orthogonality metrics may be averaged to determine an orthogonality regularization term for use in the training objective function. This orthogonality regularization term may be calculated as follows:

$$ℛ ( 𝕍 ) = {\sum }_{j = 1}^{K} {‖ {V}_{j}^{T} {V}_{j} - I ‖}_{F}^{2} / {d}_{j}^{2} , \qquad ( 5 )$$

where I is a unity matrix with the same dimension with the embedding table vⱼ, and divisors dⱼ² (j=1, . . . , K) are introduced to handle heterogeneous dimensionality of the embedding tables. In some embodiments, the embedding table Vⱼ may be first normalized with unit embedding vectors and Vⱼ in Eq. (5) is replaced by the normalized matrix V̅ⱼ.

With the introduction of the orthogonality regularization term, the optimization of the training objective function may be represented as follows

$${min}_{𝕍 , Θ} {ℒ}_{train} ( 𝕍 , Θ ) + ℛ ( 𝕍 ) \qquad ( 6 )$$

The training of the machine learning model 105 is update [symbol] and Θ such that [symbol] ₜᵣₐᵢₙ( [symbol] , Θ)+ [symbol] ( [symbol] ) in Eq. (6) is minimized. The update may be performed iteratively using training data for the machine learning model 105. With the orthogonality regularization term [symbol] ( [symbol] ), it is possible to determine orthogonal embedding vectors or near-orthogonal embedding vectors in each embedding table.

In some embodiments, a gradient-based learning algorithm may be utilized to determine increments for the model parameter values Θ and the embedding tables [symbol] according to Eq. (6). The gradient-based learning algorithm may calculates gradients of the training objective function with respect to the model parameter values Θ and the embedding tables [symbol] , and the gradients may indicate by what amount the error would increase or decrease if the model parameter values Θ and the embedding tables and the embedding tables [symbol] were increased by a tiny amount. The model parameter values Θ and the embedding tables and the embedding tables [symbol] are then adjusted in the opposite direction to the gradients. The error calculated by the training objective function is to average over all the training samples. In practice, a procedure called stochastic gradient descent (SGD) is typically used, which is well known in the art.

In some embodiments, it is desired to optimize the dimension of embedding vectors in an embedding table.

The choice of the dimension of the embedding vectors, also known as embedding dimension or embedding size, plays an important role in the overall performance of the machine learning model. Most existing models assign fixed and uniform embedding dimension for all the input fields, either due to the prerequisites of the model input or simply for the sake of convenience. If the embedding dimensions are uniformly high, it leads to increased memory usage and computational cost, as it fails to handle the heterogeneity among different features. As a concrete example, encoding input samples in an input field with few unique values with large embedding vectors definitely leads to over-parametrization. In contrast, the selected embedding dimension may be insufficient for highly-predictive features with large cardinality. Therefore, it is also desired to find appropriate embedding dimensions for different input fields. By determining appropriate embedding dimensions for different input fields, it is possible to not only reduce the memory cost for storing the embedding vectors, but also reduce the size of the model and increase inference efficiency as some model parameter values may be pruned.

In some embodiments of the present disclosure, it is proposed to learn a dimension mask to mask an embedding vector in an embedding table. The dimension mask may comprise auxiliary parameters to indicate respective importance levels of a plurality of embedding elements comprised in an embedding vector of the embedding table. The dimension mask aims to mask relatively uninformative embedding elements so as to reduce the dimension of the embedding vectors. The dimension mask may be learned together with the machine learning model.

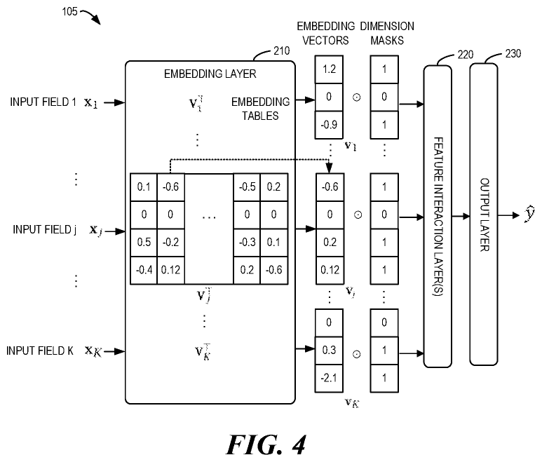

FIG. 4 illustrates a block diagram of example architecture of a machine learning model 105 in accordance with those embodiments of the present disclosure. There may be K dimension masks for the K embedding tables. As illustrated, for a certain input field, the machine learning model 105 is constructed to mask an embedding vector in an embedding table with a dimension mask for this input field. The masked embedding vector is provided to the following feature interaction layers 220 for subsequent processing.

For the training purpose, the dimension mask for a certain embedding table may be of the same dimension predetermined for the embedding table. The K dimension masks for the K embedding tables may be represented as α=[α₁; α₂; . . . ; α_{K}], where αᵢ ∈ [symbol] ^{d}^{ᵢ} is in the same dimension (size) dᵢ of the corresponding embedding vector vᵢ from the embedding table Vᵢ. According, a dimension mask αᵢ may include a dᵢ mask elements, each corresponding one of the embedding elements in the embedding vector vᵢ, to indicate an important level of this element.

In some embodiments, the dimension masks α=[α₁; α₂; . . . ; α_{K}] may be determined by training the machine learning model 105. That is, the training process of the machine learning model 105 is to determine the model parameter values, the embedding tables, and the dimension masks.

In some embodiments, a dimension mask may be a soft dimension mask, with its mask elements valued continuously from a value range, e.g., a range between [0, 1], to indicate the important levels of the corresponding embedding elements. After the dimension mask is determined through the training process, the dimension of embedding vectors may be reduced by deleting less important embedding elements indicated by the corresponding mask elements in the dimension mask. A threshold (e.g., 0.5) may be applied for the mask elements of the dimension mask, to determine which embedding elements are important and can be retained and which embedding elements are not important and can be pruned.

In some embodiments, a dimension mask may be a hard dimension mask, with its mask elements valued from two discrete values, e.g., 0 and 1, to indicate the important levels of the corresponding embedding elements. A mask element may be set to either a first value (e.g., 1) to indicate that the corresponding embedding element is important and is retained or a second value (e.g., 0) to indicate that the corresponding embedding element is pruned from each of the set of embedding vectors. After the dimension mask is determined through the training process, embedding elements in an embedding vectors that are corresponding to mask elements with the second value (e.g., 0) may be considered as not important and thus can be pruned.

In the illustrated example in FIG. 4, hard dimension masks are illustrated, with each mask element valued as either 0 or 1. For example, for the 1^{th} input field, a dimension mask [1, 0, 1] indicates that the second embedding element in embedding vectors of the embedding table V₁ is not important and can be pruned, and by masking the embedding vector with this dimension mask, a masked embedding vector [1.2, −0.9] with a reduced dimension is provided for subsequent processing. Similarly, for the j^{th} input field, a dimension mask [1, 0, 1, 1] indicates that the second embedding element in embedding vectors of the embedding table Vⱼ is not important and can be pruned, and by masking the embedding vector with this dimension mask, a masked embedding vector [−0.6, 0.2, 0.12] with a reduced dimension is provided for subsequent processing. For the K^{th} input field, a dimension mask [0, 1, 1] indicates that the first embedding element in embedding vectors of the embedding table V_{K} is not important and can be pruned, and by masking the embedding vector with this dimension mask, a masked embedding vector [0.3, −2.1] with a reduced dimension is provided for subsequent processing.

It is noted that the values for the embedding vectors and dimension masks are provided in FIG. 4 only for the purpose of illustrations. Those values may be updated in the training process of the machine learning model and are set for model application after the optimized values are found in the training process. In the following description, for the purpose of discussion, the hard dimension masks are described as example.

Provided with the dimension masks in the machine learning model 105, the predicted model output ŷ may be given as follows:

\tilde{y}=ψ(v⊙1_{α>0}|Θ)=ϕ(x| [symbol] _{α}, Θ)=ϕ(x|α, [symbol] , Θ), (7)

where [symbol] _{α}={\ddot{V}₁^{α}^{ᵢ}, . . . , \tilde{V}_{K}^{α}^{_{K}}} are the pruned embedding tables with \hat{V}ᵢ^{α}^{ᵢ}=V_{i diag(1αi>0)}, and the dimension mask αᵢ is a hard dimension mask with a value larger than 0 indicating that the corresponding embedding element is not pruned. It is noted that the embedding table here \tilde{V}ᵢ^{α}^{ᵢ} is pruned column-wisely.

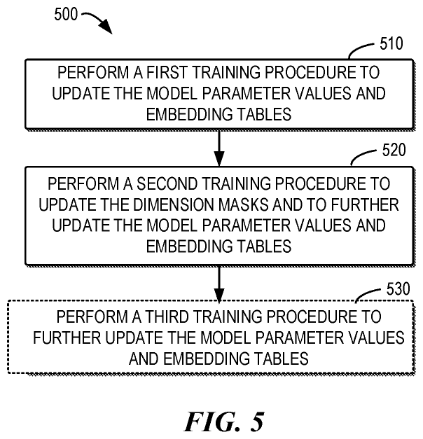

The K dimension masks for the K embedding tables may be updated and determined together with the model parameter values Θ and the embedding tables [symbol] . In some embodiments, the training process for the machine learning model 105 may be implemented with a multi-stage process. FIG. 5 illustrates a flowchart of a process 500 for training the machine learning model in accordance with these embodiments. The process 500 may be implemented at the model training system 110 in the environment 110.

At block 510, the model training system 110 performs a first training procedure on the machine learning model 105 to update the model parameter values Θ and the embedding tables [symbol] according to a training objective function (i.e., the first training objective function). The first training procedure is considered as a pre-train stage. The training objective function may be based on the one shown in Eq. (6), where the orthogonality regularization term is added to learn near-orthogonal embedding vectors in the embedding tables [symbol] .

In some embodiments, as the dimensions of embedding vectors in the embedding tables can be optimized with the dimension masks, the embedding tables may be initially set with high dimensions. In some embodiments, the dimension dⱼ for each embedding table may be determined by prior knowledge. In some embodiments, the dimension dⱼ may not exceed the field dimension Cⱼ of the embedding table, so as to avoid column-rank-deficiency.

In some embodiments, the masking operation may not be performed on the embedding vectors conveyed from the embedding layer 210 to the feature interaction layers 220. In some embodiments, during the first training procedure, the dimension masks may be set in such a way that no embedding elements are masked or pruned. In particular, the dimension masks may be set to values that indicate that embedding elements comprised in the set of embedding vectors are important and can be retained. As an example, the dimension masks may be set to have the first value (e.g., 1) for all the mask elements. For example, the dimension masks may be set as α₀=ϵ·\vec{1} or some small ϵ>0, where \vec{1} is an all-one vector.

In some embodiments, the model parameter values and the embedding tables are iteratively updated using training data in the first training procedure until stopping criteria is met. The stopping criteria may be defined as the value of the training objective function used in the first training procedure being decreased to reach a threshold value or is minimized.

The model parameter values and the embedding tables determined in the first training procedure may be passed to a next training procedure, i.e., a second training procedure, as initialization.

At block 520, the model training system 110 performs the second training procedure on the machine learning model 105 to update the K dimension masks α=[α₁; α₂; . . . ; α_{K}] and to further update the set of model parameter values Θ and the embedding tables [symbol] according to a training objective function (sometimes referred to as a “second training objective function).

The second training procedure may be considered as a search stage, to search for appropriate dimension masks for the embedding tables [symbol] . The training objective function used in the second training procedure may be at least based on the training objective function used in the first training procedure, which is related to the model output error and the orthogonality metrics between the embedding vectors of the embedding tables. A loss function related to the model output error between the may be represented as [symbol] ₜᵣₐᵢₙ( [symbol] _{α}, Θ), which is similar to [symbol] ₜᵣₐᵢₙ( [symbol] , Θ) but the embedding tables are masked with the dimension masks and thus are represented as [symbol] _{α}. The training objective function used in the second training procedure may be similar to the one shown in Eq. (6), where the orthogonality regularization term is added [symbol] ( [symbol] ) to the loss function [symbol] ₜᵣₐᵢₙ( [symbol] _{α}, Θ).

In some embodiments, there may be a target dimension size set for the embedding tables, which may be used to measure whether the dimension masks are updated in a right direction. The target dimension size may be set as a target number of mask elements having the first value or non-zero value (e.g., 1, which indicates that the corresponding embedding elements are important and can be retained. The training objective function used in the second training procedure may be further based on a difference between the number of mask elements in a dimension mask having the first value and the target number of mask elements having the first value. The training objective is to update the dimension mask such that this difference can be reduced. In some embodiments, the optimization of the training objective function used in the second training procedure may be represented as follows:

$${min}_{α} {min}_{𝕍 , Θ} {ℒ}_{train} ( {\overline{𝕍}}_{α} , Θ ) + μ \vert {‖ {1}_{α > 0} ‖}_{1} - s \vert + ℛ ( 𝕍 ) \qquad ( 8 )$$

where ∥1_{α>0}∥₁ counts the number of non-zero value mask elements in each dimension mask and s is the target number of non-zero mask elements. In the training objective function in Eq. (8), instead of direct regularization on the number ∥1_{α>0}∥₁, the target number s is included to reduce instability from batched training and the choice of the hyperparameter μ. The updates on the K dimension masks α, the model parameter values Θ and the set of embedding vectors [symbol] may be performed iteratively using training data for the machine learning model 105. The term ∥1_{α>0}∥₁−s in Eq. (8) may help push the optimization process to iteratively evaluate the machine learning model with the dimension masks.

In some embodiments, when applying a gradient-based learning algorithm to determine the updates to the dimension masks α, the training objective function in Eq. (8) above is non-differentiable with respect to α at 0 and has zero gradient anywhere else. Thus, traditional gradient descent algorithms may not be applicable. To that end, in some embodiments, the straight-through estimator (STE) may be applied, which replaces the ill-defined gradient in the chain rule by a fake gradient.

In some embodiments, an identity function may be applied for back-propagation according to the STE. For any dimension mask, a mask element(s) having the second value (e.g., 0, which indicates that the corresponding embedding element(s) is not important and can be pruned) may be deleted from the dimension mask, to obtain an adjusted dimension mask. A gradient of the training objective function may be calculated with respect to the adjusted dimension mask, and may be used to determine an update (increment) to the dimension mask. The calculation of the gradient with respect to the adjusted dimension mask may be represented as follows:

$$\frac{\partial ℒ}{\partial α} = \frac{\partial ℒ}{\partial {1}_{α > 0}} \frac{\partial {1}_{α > 0}}{\partial α} \approx \frac{\partial ℒ}{\partial {1}_{α > 0}} \frac{\partial α}{\partial α} = \frac{\partial ℒ}{\partial {1}_{α > 0}} \qquad ( 9 )$$

where [symbol] represents the training objective function used in the second training procedure, 1_{α>0} represents the adjusted dimension masks to be udpated. According to Eq. (9), the non-differentiable term

$$\frac{\partial {1}_{α > 0}}{\partial α}$$

is replaced by

$$\frac{\partial α}{\partial α} .$$

Thus, the caculating of the gradient with respect to the K dimension masks α is equivalent to the caculating of the gradient with respect to the K adjusted dimension masks 1_{α>0} for the K embedding tables.

In some embodiments, at the beginning of the second training procedure, the dimension masks may be set in such a way that no embedding elements are masked or pruned. In particular, the dimension masks may be set to values that indicate that embedding elements comprised in the set of embedding vectors are important and can be retained. As an example, the dimension masks may be set to have the first value (e.g., 1) for all the mask elements. For example, the dimension masks may be set as α₀=ϵ·\vec{1} for some small ϵ>0, where \vec{1} is an all-one vector.

The gradient update rules for the dimension masks α at an iteration t may be given by:

αₜ₊₁=αₜ−∇₍₁_{_{α>0}}₎ [symbol] _{batch}−μ·sign(∥1_{α>0}∥₁−s)\vec{1} (10)

where αₜ represents the dimension masks at an iteration t, αₜ₊₁ represents the updated dimension masks, and ∇₍₁_{_{α>0}}₎ [symbol] _{batch}−μ·sign(∥1_{α>0}∥₁−s)\vec{1} represents the update based on the gradient.

In some embodiments, in the second training procedure, to enhance the stability and performance, a multi-step training may be implemented through iteratively training the dimension masks on validation training data and re-update the model parameter values and the embedding tables, which attempts to solve the following bi-level optimization problem with the training objective function:

$${min}_{α} {ℒ}_{val} ( {\overline{𝕍}}_{α}^{*} , {Θ}^{*} ) + μ \vert {‖ {1}_{α > 0} ‖}_{1} - s \vert + ℛ ( 𝕍 ) \\ s . t . {\overline{𝕍}}_{α}^{*} , {Θ}^{*} = {argmin}_{{\overline{𝕍}}_{α} , Θ} {ℒ}_{train} ( {\overline{𝕍}}_{α} , Θ ) + ℛ ( 𝕍 ) \qquad ( 11 )$$

According to Eq. (11), the dimension masks α are updated by applying training data batches from a validation dataset according to the training objective function

$${min}_{α} {ℒ}_{val} ( {\overline{𝕍}}_{α}^{*} , {Θ}^{*} ) + μ \vert {‖ {1}_{α > 0} ‖}_{1} - s \vert + ℛ ( 𝕍 ) ,$$

and then the model parameter values Θ and the set of embedding vectors [symbol] are updated by applying training data batches from a training dataset according to the training objective

$${argmin}_{{\overline{𝕍}}_{α} , Θ} {ℒ}_{train} ( {\overline{𝕍}}_{α} , Θ ) + ℛ ( 𝕍 )$$

which does not include the term μ|∥1_{α>0}∥₁−s|. The updating are performed iteratively until stopping criteria is met. The stopping criteria may be defined as the value of the training objective function

$${min}_{α} {ℒ}_{val} ( {\overline{𝕍}}_{α}^{*} , {Θ}^{*} ) + μ \vert {‖ {1}_{α > 0} ‖}_{1} - s \vert + ℛ ( 𝕍 ) and$$

$${argmin}_{{\overline{𝕍}}_{α} , Θ} {ℒ}_{train} ( {\overline{𝕍}}_{α} , Θ ) + ℛ ( 𝕍 )$$

being decreased to reach a threshold value or is minimized. The updated dimension mask remains unchanged during the updating of the model parameter values Θ and the set of embedding vectors [symbol] .

In some embodiments, at block 530, the model training system 110 may perform a third training procedure on the machine learning model to further update the model parameter values Θ and the embedding tables [symbol] according to a training objective function (sometimes referred to as a “third training objective function). The third training procedure is a re-train stage. In third training procedure, the training objective function may be set as [symbol] ₜᵣₐᵢₙ(\tilde{V}_{α}, Θ)+ [symbol] ( [symbol] ), with the model output error and the orthogonality metrics between the embedding vectors considered. The dimension masks obtained from the second training procedure remain unchanged during the third training procedure.

In third training procedure, the model parameter values Θ and the embedding tables [symbol] are iteratively updated until stopping criteria is met. The stopping criteria may be defined as the value of the training objective function [symbol] ₜᵣₐᵢₙ(\tilde{V}_{α}, Θ)+ [symbol] ( [symbol] ) being decreased to reach a threshold value or is minimized.

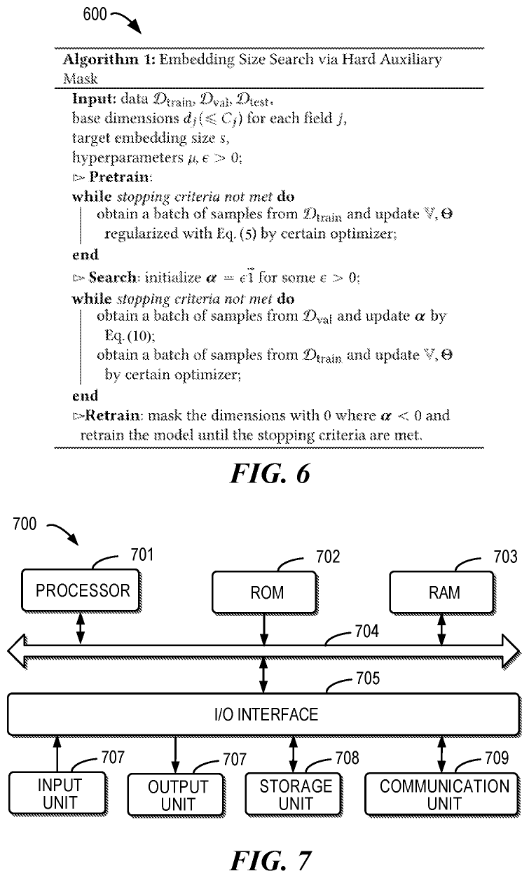

FIG. 6 illustrates an example algorithm 600 for training the machine learning model in accordance with some example embodiments of the present disclosure. The example algorithm 600 may be considered as an example of the process 500.

According to the algorithm 600, the first training procedure is a pre-train stage to train the machine learning model 105 to optimize the embedding tables and the set of model parameter values until a topping criteria is met; the second training procedure is a search stage to train the machine learning model 105 to optimize the dimension masks and further optimize the embedding tables and the set of model parameter values until a topping criteria is met; the third training procedure is a retrain stage to train the machine learning model 105 to further optimize the embedding tables and the set of model parameter values while applying the dimension masks to mask the embedding vectors.

After the training, the model parameter values, the embedding tables, and the dimension masks for the embedding tables are all determined for the machine learning model. A determined dimension mask may be used to mask each embedding vector in a corresponding dimension table, to prune the embedding elements corresponding to the mask elements indicating that those elements are not important and can be pruned. As a result, the dimension of the embedding vectors can be reduced and less embedding values are provided for storage and for use in the model application phase.

In addition, a subset of the model parameter values that are directly applied to the embedding vectors of the embedding table may be masked with all the K dimension mask, to prune the model parameter values that are applied to those pruned embedding elements. Specifically, the subset of model parameter values configured for the first feature interaction layer which is directly connected to the embedding layer may be masked with the K dimension mask, to prune part of the parameter values. The size of the trained machine learning model can be reduced as its parameter size is decreased and accordingly, the interference efficiency can also be improved. The trained machine learning model with the masked model parameter values and the masked embedding tables may be provided for use in model application, provided to the model application system 120 in the environment 100.

FIG. 7 illustrates a block diagram of an example computing system/device 700 suitable for implementing example embodiments of the present disclosure. The model training system 110 and/or the model application system 120 may be implemented as or included in the system/device 700. The system/device 700 may be a general-purpose computer, a physical computing device, or a portable electronic device, or may be practiced in distributed cloud computing environments where tasks are performed by remote processing devices that are linked through a communication network. The system/device 700 can be used to implement any of the processes described herein.

As depicted, the system/device 700 includes a processor 701 which is capable of performing various processes according to a program stored in a read only memory (ROM) 702 or a program loaded from a storage unit 708 to a random access memory (RAM) 703. In the RAM 703, data required when the processor 701 performs the various processes or the like is also stored as required. The processor 701, the ROM 702 and the RAM 703 are connected to one another via a bus 704. An input/output (I/O) interface 705 is also connected to the bus 704.

The processor 701 may be of any type suitable to the local technical network and may include one or more of the following: general purpose computers, special purpose computers, microprocessors, digital signal processors (DSPs), graphic processing unit (GPU), co-processors, and processors based on multicore processor architecture, as non-limiting examples. The system/device 700 may have multiple processors, such as an application-specific integrated circuit chip that is slaved in time to a clock which synchronizes the main processor.

A plurality of components in the system/device 700 are connected to the I/O interface 705, including an input unit 706, such as a keyboard, a mouse, or the like; an output unit 707 including a display such as a cathode ray tube (CRT), a liquid crystal display (LCD), or the like, and a loudspeaker or the like; the storage unit 708, such as disk and optical disk, and the like; and a communication unit 709, such as a network card, a modem, a wireless transceiver, or the like. The communication unit 709 allows the system/device 700 to exchange information/data with other devices via a communication network, such as the Internet, various telecommunication networks, and/or the like.

The methods and processes described above, such as the process 400, can also be performed by the processor 701. In some embodiments, the process 400 can be implemented as a computer software program or a computer program product tangibly included in the computer readable medium, e.g., storage unit 708. In some embodiments, the computer program can be partially or fully loaded and/or embodied to the system/device 700 via ROM 702 and/or communication unit 709. The computer program includes computer executable instructions that are executed by the associated processor 701. When the computer program is loaded to RAM 703 and executed by the processor 701, one or more acts of the process 400 described above can be implemented.

Alternatively, processor 701 can be configured via any other suitable manners (e.g., by means of firmware) to execute the process 400 in other embodiments.

In some example embodiments of the present disclosure, there is provided a computer program product comprising instructions which, when executed by a processor of an apparatus, cause the apparatus to perform steps of any one of the methods described above.

In some example embodiments of the present disclosure, there is provided a computer readable medium comprising program instructions for causing an apparatus to perform at least steps of any one of the methods described above. The computer readable medium may be a non-transitory computer readable medium in some embodiments.

In an eighth aspect, example embodiments of the present disclosure provide a computer readable medium comprising program instructions for causing an apparatus to perform at least the method in the second aspect described above. The computer readable medium may be a non-transitory computer readable medium in some embodiments.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present disclosure are illustrated and described as block diagrams, flowcharts, or using some other pictorial representations, it will be appreciated that the blocks, apparatuses, systems, techniques, or methods described herein may be implemented in, as non-limiting examples, hardware, software, firmware, special purpose circuits or logic, general purpose hardware or controller or other computing devices, or some combination thereof

The present disclosure also provides at least one computer program product tangibly stored on a non-transitory computer readable storage medium. The computer program product includes computer-executable instructions, such as those included in program modules, being executed in a device on a target real or virtual processor, to carry out the methods/processes as described above. Generally, program modules include routines, programs, libraries, objects, classes, components, data structures, or the like that perform particular tasks or implement particular abstract types. The functionality of the program modules may be combined or split between program modules as desired in various embodiments. Computer-executable instructions for program modules may be executed within a local or distributed device. In a distributed device, program modules may be located in both local and remote storage media.

The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods disclosed herein may be written in any combination of one or more programming languages. The program code may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method comprising:
determining a set of model parameter values for a machine learning model and a set of embedding vectors for an input field of the machine learning model, the machine learning model being constructed to map an input sample in the input field to an embedding vector in the set of embedding vectors and process the embedding vector with the set of model parameter values to generate a model output; and
training the machine learning model by updating the set of model parameter values and the set of embedding vectors according to at least a first training objective function, the first training objective function being based on an orthogonality metric between embedding vectors in the set of embedding vectors and based on a difference between the model output and a ground-truth model output.

2. The method of claim 1, wherein the orthogonality metric is determined based on the following:
constructing a matrix comprising the set of embedding vectors;
determining a difference between a transpose of the matrix times the matrix itself and an identity matrix; and
determining the orthogonality metric based on the difference.

3. The method of claim 1, wherein the machine learning model is further constructed to mask the embedding vector with a dimension mask for the input field and process the masked embedding vector with the set of model parameter values to generate the model output,
wherein the dimension mask indicates respective importance levels of a plurality of embedding elements comprised in each of the set of embedding vectors.

4. The method of claim 3, wherein training the machine learning model comprises:
performing a first training procedure on the machine learning model to update the set of model parameter values and the set of embedding vectors according to the first training objective function, and
performing a second training procedure on the machine learning model to update the dimension mask and to further update the set of model parameter values and the set of embedding vectors according to a second training objective function,
wherein the second training objective function is at least based on the orthogonality metric and the difference between the model output generated with the set of model parameter values and a ground-truth model output.

5. The method of claim 4, wherein during the first training procedure, the dimension mask is set to indicate that embedding elements comprised in the set of embedding vectors are important and are retained.

6. The method of claim 4, wherein performing the second training procedure comprises: iteratively performing the following until the second training objective function reaches a threshold value,
updating the dimension mask using a first training data batch for the machine learning model; and
updating the set of model parameter values and the set of embedding vectors using a second training data batch for the machine learning model, wherein the updated dimension mask remain unchanged during the updating of the set of model parameter values and the set of embedding vectors.

7. The method of claim 4, wherein the dimension mask comprises a plurality of mask elements corresponding to a plurality of embedding elements comprised in each of the set of embedding vectors, each mask element having either a first value to indicate that the corresponding embedding element is important and is retained or a second value to indicate that the corresponding embedding element is pruned from each of the set of embedding vectors.

8. The method of claim 7, wherein the second training objective function is further based on a difference between the number of mask elements in the dimension mask having the first value and a target number of mask elements having the first value.

9. The method of claim 8, wherein the dimension mask is updated based on the following:
determining a first adjusted dimension mask by deleting at least one element having the second value from the dimension mask;
determining a gradient of the second training objective function with respect to the adjusted dimension mask; and
updating the dimension mask based on the determined gradient.

10. The method of claim 4, wherein training the machine learning model further comprises:
performing a third training procedure on the machine learning model to further update the set of model parameter values and the set of embedding vectors obtained after the second training procedure,
wherein the third training objective function is based on the orthogonality metric and the difference between the model output and a ground-truth model output, and wherein the dimension mask obtained after the second training procedure remains unchanged during the third training procedure.

11. The method of claim 4, further comprising:
determining a set of masked embedding vectors by masking each of the set of embedding vectors with the dimension mask;
determining the trained machine learning model by masking, with the dimension mask, a subset of the set of model parameter values that are directly applied to an embedding vector of the set of the embedding vector; and
providing the set of masked embedding vectors and the trained machine learning model.

12. The method of claim 1, wherein training the machine learning model further comprises:
determining a further set of embedding vectors for a further input field of the machine learning model, the machine learning model being constructed to map a further input sample in the further input field to a further embedding vector in the further set of embedding vectors and process the further embedding vector with the set of model parameter values to generate a model output; and
training the machine learning model by updating the set of model parameter values, the set of embedding vectors, and the further set of embedding vectors according to at least the first training objective function,
wherein the first training objective function is further based on an orthogonality metric between embedding vectors in the further set of embedding vectors.

13. A system, comprising:
at least one processor; and
at least one memory communicatively coupled to the at least one processor and comprising computer-readable instructions that upon execution by the at least one processor cause the at least one processor to perform acts comprising:
determining a set of model parameter values for a machine learning model and a set of embedding vectors for an input field of the machine learning model, the machine learning model being constructed to map an input sample in the input field to an embedding vector in the set of embedding vectors and process the embedding vector with the set of model parameter values to generate a model output; and
training the machine learning model by updating the set of model parameter values and the set of embedding vectors according to at least a first training objective function, the first training objective function being based on an orthogonality metric between embedding vectors in the set of embedding vectors and based on a difference between the model output and a ground-truth model output.

14. The system of claim 13, wherein the orthogonality metric is determined based on the following:
constructing a matrix comprising the set of embedding vectors;
determining a difference between a transpose of the matrix times the matrix itself and an identity matrix; and
determining the orthogonality metric based on the difference.

15. The system of claim 13, wherein the machine learning model is further constructed to mask the embedding vector with a dimension mask for the input field and process the masked embedding vector with the set of model parameter values to generate the model output,
wherein the dimension mask indicates respective importance levels of a plurality of embedding elements comprised in each of the set of embedding vectors.

16. The system of claim 15, wherein training the machine learning model comprises:
performing a first training procedure on the machine learning model to update the set of model parameter values and the set of embedding vectors according to the first training objective function, and
performing a second training procedure on the machine learning model to update the dimension mask and to further update the set of model parameter values and the set of embedding vectors according to a second training objective function,
wherein the second training objective function is at least based on the orthogonality metric and the difference between the model output generated with the set of model parameter values and a ground-truth model output.

17. The system of claim 16, wherein during the first training procedure, the dimension mask is set to indicate that embedding elements comprised in the set of embedding vectors are important and are retained.

18. The system of claim 16, wherein the dimension mask comprises a plurality of mask elements corresponding to a plurality of embedding elements comprised in each of the set of embedding vectors, each mask element having either a first value to indicate that the corresponding embedding element is important and is retained or a second value to indicate that the corresponding embedding element is pruned from each of the set of embedding vectors.

19. The system of claim 18, wherein the second training objective function is further based on a difference between the number of mask elements in the dimension mask having the first value and a target number of mask elements having the first value.

20. A non-transitory computer-readable storage medium, storing computer-readable instructions that upon execution by a computing device cause the computing device to perform acts comprising:
determining a set of model parameter values for a machine learning model and a set of embedding vectors for an input field of the machine learning model, the machine learning model being constructed to map an input sample in the input field to an embedding vector in the set of embedding vectors and process the embedding vector with the set of model parameter values to generate a model output; and
training the machine learning model by updating the set of model parameter values and the set of embedding vectors according to at least a first training objective function, the first training objective function being based on an orthogonality metric between embedding vectors in the set of embedding vectors and based on a difference between the model output and a ground-truth model output.
